(19) United States
(12) Patent Application Publication
(10) Pub. No.: US 2023/0139674 A1
(43) Pub. Date: May 4, 2023

(54) Electrochemical Cell having Improved Thermal Dissipation

(71) Applicant: STOREDOT LTD., Herzeliya (IL)

(72) Inventor: Dan Corfas, Kfar Saba (IL)

(73) Assignee: STOREDOT LTD., Herzeliya (IL)

(21) Appl. No.: 18/052,557

(22) Filed: Nov. 3, 2022

Related U.S. Application Data
(60) Provisional application No. 63/263,512, filed on Nov. 3, 2021.

(51) Int. Cl. H01M 10/654; H01M 50/531; H01M 50/131; H01M 50/54; H01M 50/538; H01M 10/613

(52) U.S. Cl. CPC H01M 10/654; H01M 50/531; H01M 50/131; H01M 50/54; H01M 50/538; H01M 10/613; H01M 2004/028

(57) ABSTRACT

An electrochemical electrode that includes electrode active material, and a current conductor that includes a coated portion that is coated with the electrode active material, a heat transfer portion and a current pad. The heat transfer portion and the current pad are external to the electrode active material. The current pad differs from the heat transfer portion.

### BACKGROUND

Electrochemical devices, such as cells, supercapacitors, etc. tend to heat in various conditions.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A illustrates a part of a prior art cell;

FIG. 1B illustrates a prior art electrode;

FIG. 2A illustrates an example of an electrode;

FIGS. 2B and 2C illustrate examples of a current collector;

FIGS. 2D and 2E illustrate examples of a cross section of an electrode;

FIGS. 3A, 3B, 3C, 3D, 3E and 3F illustrate examples of a part of a battery;

FIGS. 4A and 4B illustrate examples of a part of a battery;

FIGS. 4C and 4D illustrate examples of a part of a battery and of a heat dissipating element;

FIG. 5 illustrates an example of a part of a battery; and

FIG. 6 illustrates an example of a method.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a cell capable of executing the method.

Any reference in the specification to a cell should be applied mutatis mutandis to a method that may be executed by the system.

Increasing temperature of electrochemical device during its operation might damage the cell's performance and cycle life, and also cause safety issues.

The higher the capacity of the cell, its power, and its volume are, the more difficult it is to evacuate heat from the cell.

Good heat dissipation requires good thermal conductivity.

The thermal conductivity in the direction of the electrodes is much higher than the thermal conductivity in the perpendicular direction.

There are provided an electrode and a battery that use a current collector of an electrode not only as electrical (current) conductor, but also as a thermal conductor.

A prior art electrode (for example cathode or anode), had a single electrical or thermal connection apart from the current collector's pad, that is connected to the electrical circuit via bus-bar, welding, or any other electrical connection method—whereas the current collector's pad is the only bare part (uncoated) of the electrode.

There is provided a thermal connection of the current collector, or any heat-conductive part of the cell, that can conduct heat to the case of the cell, or to an outer heat sink or cooling device.

There may be provided an electrochemical electrode that includes an electrode active material and a current conductor. The current conductor may include a coated portion that is coated with the electrode active material, a heat transfer portion and a current pad, wherein the heat transfer portion and the current pad are external to the electrode active material, and wherein the current pad differs from the heat transfer portion.

There may be any angular relationship between the current pad and the heat transfer portion. There may be any angular relationship between the coated portion and the heat transfer portion.

For example—the current pad may be oriented to the heat transfer portion. The heat transfer portion may be oriented to the coated portion The heat transfer portion may be parallel to the coated portion. The heat transfer portion may be substantially perpendicular to the coated portion.

The heat transfer portion may extend from one side of the coated region and the current pad extends from another side of the coated region. The one side may be oriented to the other side or be opposite to the other side.

There may be provided an electrochemical battery that may include multiple electrodes that include at least one anode and at least one cathode. A first electrode of the multiple electrodes may include electrode active material and a current conductor that may include a coated portion that is coated with the electrode active material, a heat transfer portion and a current pad, wherein the heat transfer portion and the current pad are external to the electrode active material, and wherein the current pad differs from the heat transfer portion.

The heat transfer portion may form a part of an exterior of the electrochemical battery.

The electrochemical battery may include a housing and the heat transfer portion may contact the housing or may be proximate to the housing.

The electrochemical battery may include a heat dissipation element that is in thermal communication with the heat transfer portion—the thermal communication facilitates a transfer of heat between the heat dissipation element and the heat transfer portion.

The electrochemical battery may include a group of first electrodes of the multiple electrodes, wherein each first electrode of the group of first electrodes may include electrode active material and a current conductor that may include a coated portion that is coated with the electrode active material, a heat transfer portion and a current pad, wherein the heat transfer portion and the current pad are external to the electrode active material, and wherein the current pad differs from the heat transfer portion.

Heat transfer portions of two or more first electrodes of the group of first electrodes may contact each other.

Heat transfer portions of two or more first electrodes of the group of first electrodes may be spaced apart from each other.

The group of first electrodes may include an anode and a cathode, only one or more anodes, only one or more cathodes, anodes and at least one cathode, cathodes and at least one anode, or anodes and cathodes.

The electrochemical battery may be of different types—for example—z-folded, stacked, winded, and the like.

It should be noted that heat transfer element may be folded at an angle, substantially perpendicular (for example at an angle between eighty and one hundred degrees) or oriented (in relation to the coated portion of the current collector) at any other angle, so that it has a larger surface area presented to the cell case

A battery may include multiple heat transfer elements—that may contact each other or may be separated from each other.

The heat transfer elements can be in thermal communication (by contact or by proximity without contact) to heat dissipating elements such as a heat sink. The heat dissipating elements may be included in a housing of the battery, may be proximate to the housing of the battery, and the like. Proximate may mean within a distance that will allow at least a predefined percent (for example—between 10% to 90%, or between 40% to 80%) of heat to be conveyed from a heat dissipating element and the hear dissipating elements. Proximate may be distant apart by a distance that may range between 0.1 and 5 centimeters, by 0.1 till 0.9 centimeter, by less than 1.5 centimeters, by less than 3 centimeters, and the like.

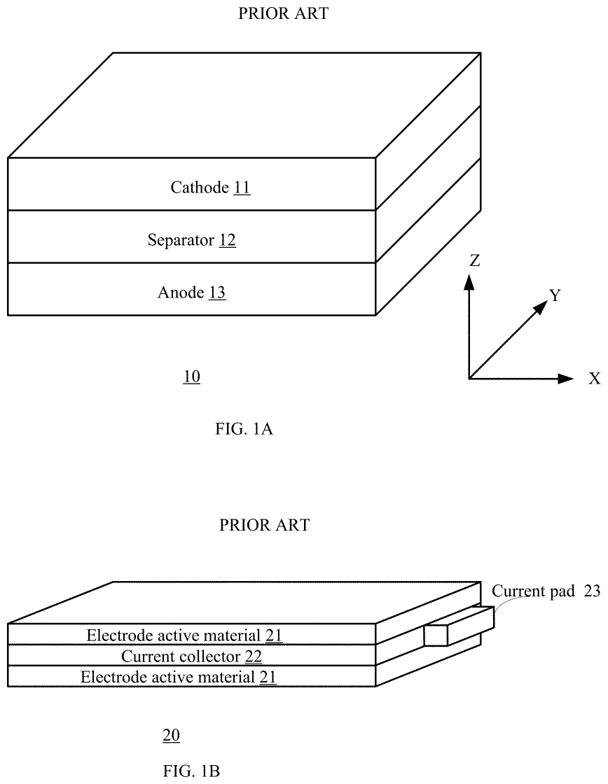

FIG. 1A illustrates a part of a prior art cell 10 that include a cathode 11, separator 12 and anode 13 that are positioned one above the other—along a Z axis. The thermal conductance of the cell along the Z axis (Kz) is much smaller than the thermal conductance of the cell along the x-axis (Kx) and the thermal conductance along the y-axis (Ky).

FIG. 1B illustrates a prior art electrode 20 that includes a current collector 22 that is coated by electrode active material 21 on both sides and has a current pad 23 that extends from the electrode active material. The current pan is connected to a conductive path for conveying current.

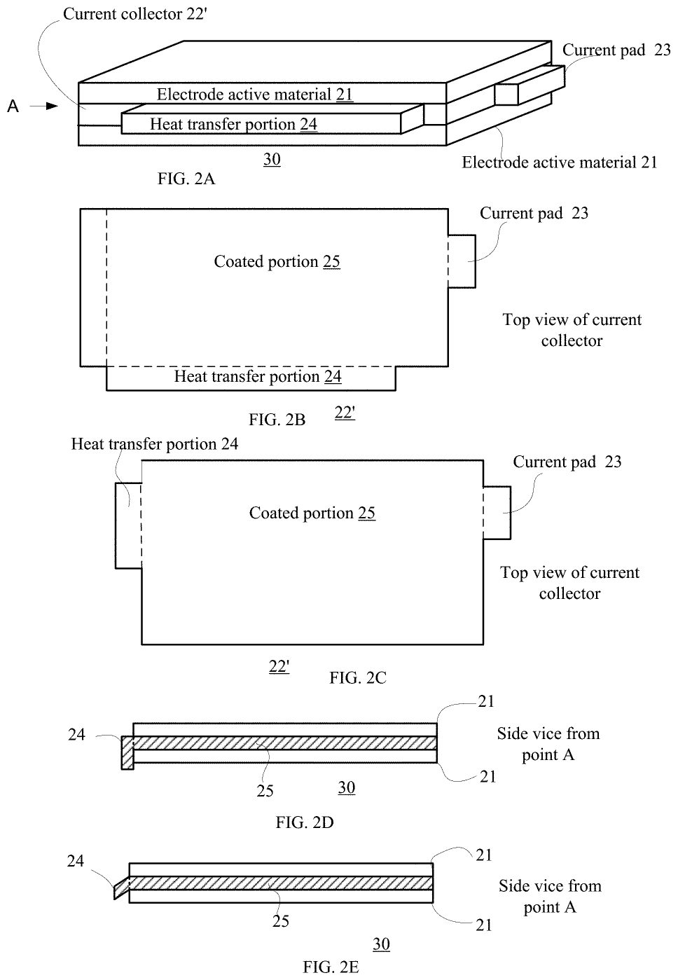

FIG. 2A illustrates an example of an electrode that includes a current collector that has a coated portion (denoted 25 in FIGS. 2B and 2C) located between the electrode active material 21, a current pad 23 that extends outside the coated portion and a heat transfer portion 24 that also extends outside the electrode active material. In FIG. 2A the heat transfer portion 24 and the current pad 23 extend from different sides of the coated portion.

FIGS. 2B and 2C illustrate examples of current collectors 22′ that include coated portion 25, heat transfer portion 24 and current pad 23. The current collectors of FIGS. 2B and 2C differ from each other by the location of the heat transfer portion 24.

FIGS. 2D and 2E illustrate examples of a cross section of an electrode 30—and illustrate two of the possible orientations between the heat transfer portion 24 and the electrode active material 21.

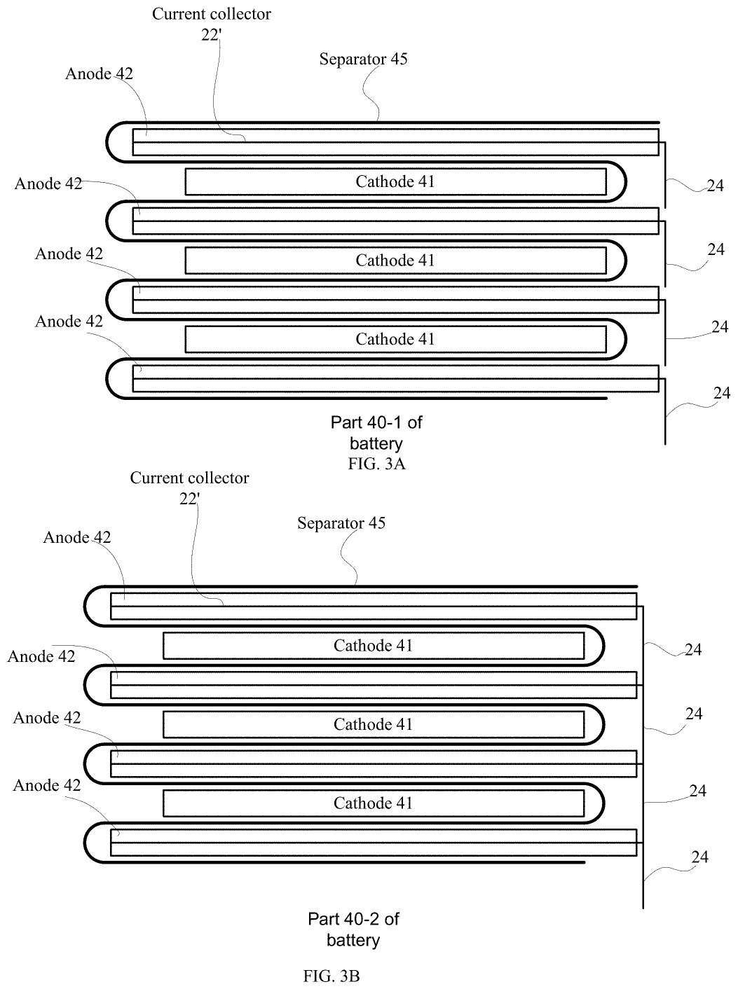

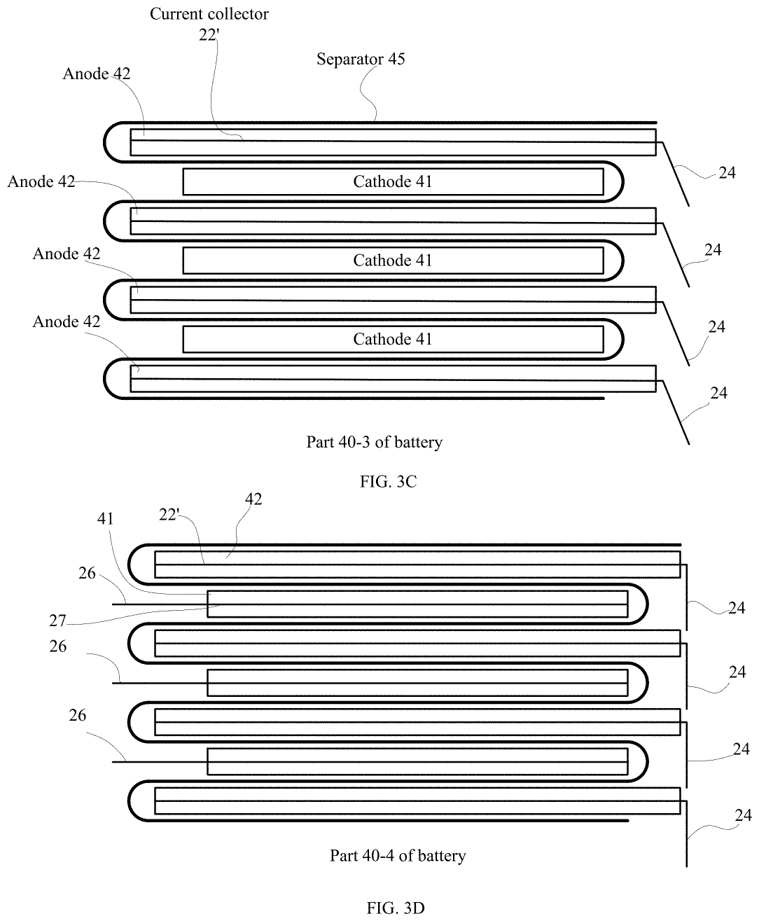

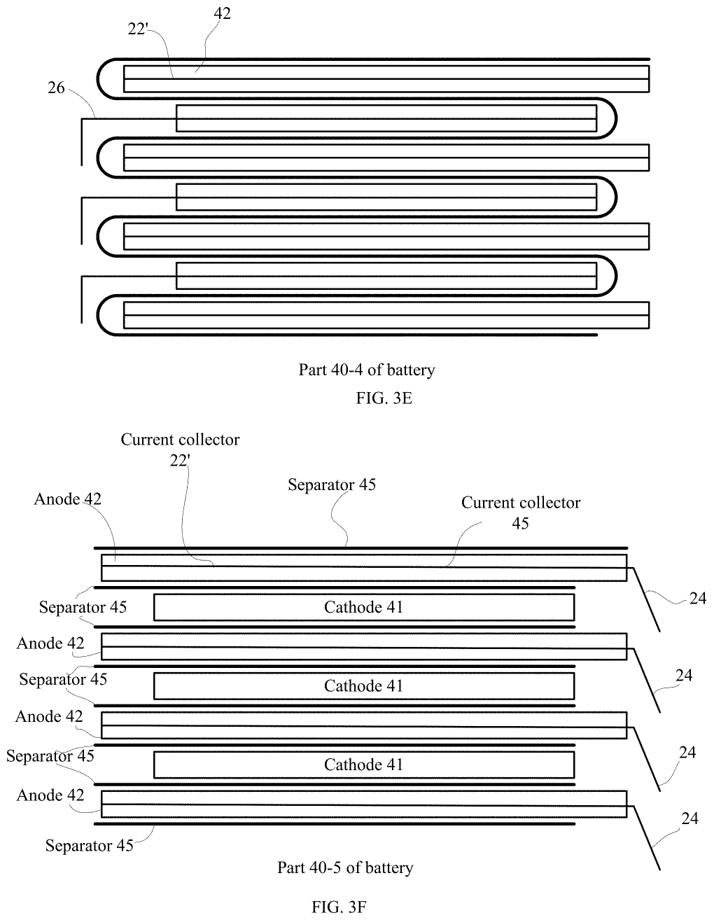

FIGS. 3A, 3B, 3C, 3D, 3E and 3F illustrate examples of parts (40-1, 40-2, 40-3, 40-4, 40-5 and 40-6) of a battery.

The parts of batteries of FIGS. 3A-3E include anodes 42, cathodes 41, an s-shaped separator 45 that separates the anodes from the cathodes. In some of the figures there are current collectors 22′ within the anodes that include heat transfer portion 24 (positioned at one or more different angles of orientation). In some of the figures there are current collectors 27 within the cathodes that include heat transfer portion 26 (at one or more different angles of orientation). For simplicity of explanation the current collectors of cathodes that did not include a heat transfer portion were not shown in the figure.

In some of the figures heat transfer portions of different electrodes contact each other while in some of the figures the heat transfer positions of different electrodes were spaced apart from each other.

Part of battery 40-6 of FIG. 3F illustrated a stacked battery that has multiple separators instead of the S-shaped separator.

The batteries that include any of the parts of FIGS. 3A-3F also include current pads which were not shown—for simplicity of explanation. These batteries may include various current collectors—such as any of the current collectors of FIGS. 2A-2E. Any electrode that has a heat transfer portion is referred to as a first electrode.

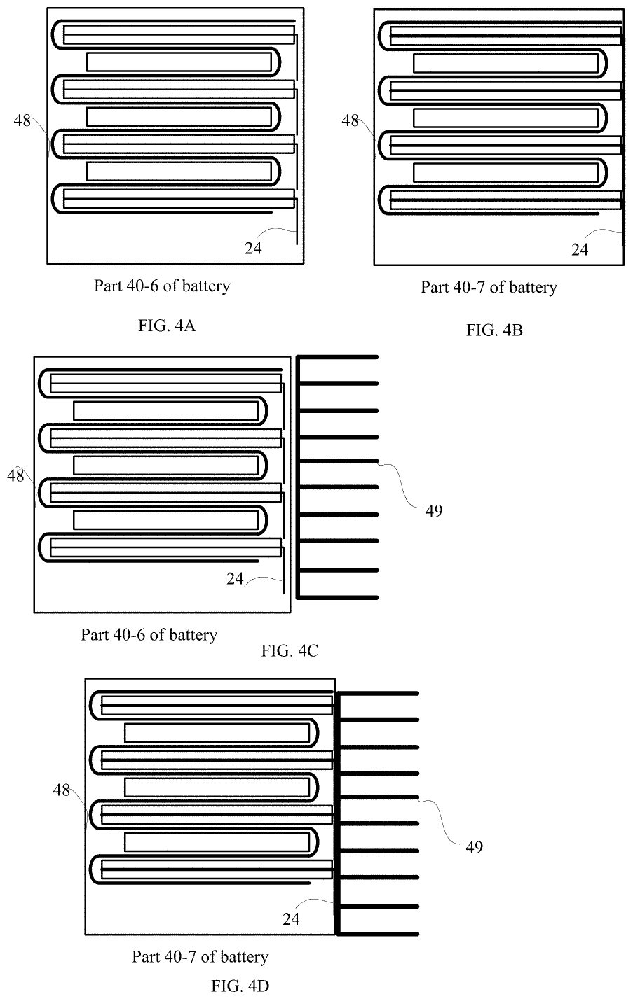

FIGS. 4A and 4B illustrate examples of parts 40-6 and 40-7 of a battery. Part 40-6 illustrates an example where the heat transfer portions 24 are within housing 48 of the battery—but proximate to the housing. The heat transfer portions 24 may contact the housing or not.

Part 40-6 illustrates an example where the heat transfer portions 24 are a part of the exterior of the housing 48 of the battery.

FIGS. 4C and 4D illustrate examples of parts 40-6 and 40-7 of a battery and a heat dissipating element such as heat sink 49.

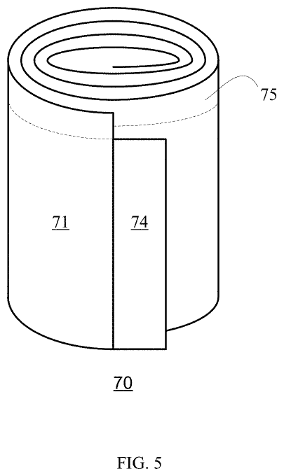

FIG. 5 illustrates an example of a part 70 of a battery that is a winded battery. A current collector may include a coated part 41, an upper current tap 75 and a heat transfer portion.

In any of the figures the heat transfer portion may not be coated by the electrode active material, or may include at least one or more regions (from one side of the heat transfer portion or from two or more sides of the heat transfer portion) that are not coated by the electrode active material.

The electrode or the battery may be included in a fast charging battery such as an ion lithium battery—and/or of any other battery having a charging rage of at least 1C, 3C, 5C, 10C, 20C, 50C, 80C, 100C and the like.

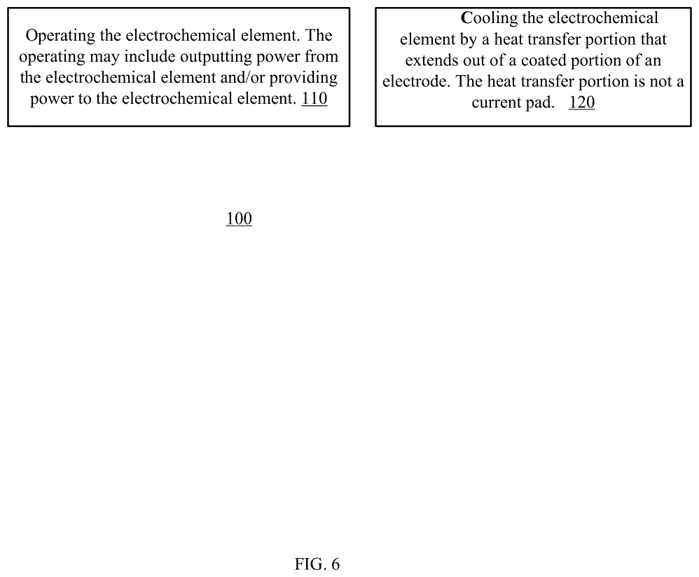

FIG. 6 illustrates method 100 for cooling an electrochemical element.

Method 100 may include steps 110 and 120.

Step 110 may include operating the electrochemical element. The operating may include outputting power from the electrochemical element and/or providing power to the electrochemical element. Step 110 may include performing one or multiple chare and discharge cycles of the electrochemical element.

Step 120 may include cooling the electrochemical element by a heat transfer portion that extends out of a coated portion of an electrode. The heat transfer portion is not a current pad.

The electrochemical element may be an electrode, an anode, a battery, and the like.

The electromechanical element may be any of the electrodes illustrated in the specification or may be any battery illustrated in the specification.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An electrochemical electrode that comprises:
electrode active material;
a current conductor that comprises a coated portion that is coated with the electrode active material, a heat transfer portion and a current pad, wherein the heat transfer portion and the current pad are external to the electrode active material, and wherein the current pad differs from the heat transfer portion.

2. The electrochemical electrode according to claim 1 wherein the current pad is oriented to the heat transfer portion.

3. The electrochemical electrode according to claim 1 wherein the heat transfer portion is oriented to the coated portion.

4. The electrochemical electrode according to claim 1 wherein the heat transfer portion is parallel to the coated portion.

5. The electrochemical electrode according to claim 1 wherein the heat transfer portion is substantially perpendicular to the coated portion.

6. The electrochemical electrode according to claim 1 wherein the heat transfer portion extend from one side of the coated region and the current pad extends from another side of the coated region.

7. An electrochemical battery that comprises:
multiple electrodes that comprise at least one anode and at least one cathode;
wherein a first electrode of the multiple electrodes comprises electrode active material and a current conductor that comprises a coated portion that is coated with the electrode active material, a heat transfer portion and a current pad, wherein the heat transfer portion and the current pad are external to the electrode active material, and wherein the current pad differs from the heat transfer portion.

8. The electrochemical battery according to claim 7, wherein the heat transfer portion forms a part of an exterior of the electrochemical battery.

9. The electrochemical battery according to claim 7, comprising a housing, wherein the heat transfer portion contacts the housing.

10. The electrochemical battery according to claim 7, comprising a housing, wherein the heat transfer portion is proximate to the housing.

11. The electrochemical battery according to claim 7, comprising heat dissipation element that is in thermal communication with the heat transfer portion.

12. The electrochemical battery according to claim 7, wherein the first electrode belongs to a group of first electrodes of the multiple electrodes, wherein each first electrode of the group of first electrodes comprises electrode active material and a current conductor that comprises a coated portion that is coated with the electrode active material, a heat transfer portion and a current pad, wherein the heat transfer portion and the current pad are external to the electrode active material, and wherein the current pad differs from the heat transfer portion.

13. The electrochemical battery according to claim 12, wherein heat transfer portions of two or more first electrodes of the group of first electrodes contact each other.

14. The electrochemical battery according to claim 12, wherein heat transfer portions of two or more first electrodes of the group of first electrodes are spaced apart from each other.

15. The electrochemical battery according to claim 12, wherein the group of first electrodes comprises an anode and a cathode.

16. The electrochemical battery according to claim 12, wherein the group of first electrodes comprises one or more anodes.

17. The electrochemical battery according to claim 7 wherein the electrochemical battery is a z-folded battery.

18. The electrochemical battery according to claim 7 wherein the electrochemical battery is a stacked battery.

19. The electrochemical battery according to claim 7 wherein the electrochemical battery is a winded battery.

20. A method for cooling an electrochemical element, the method comprises:
operating the electrochemical element; wherein the operating comprises outputting power from the electrochemical element or providing power to the electrochemical element; and
cooling the electrochemical element by a heat transfer portion that extends out of a coated portion of an electrode.
